(19) United States
(12) Patent Application Publication
(10) Pub. No.: US 2002/0006257 A1
(43) Pub. Date: Jan. 17, 2002

(54) Method and system for compensating for chromatic dispersion

(76) Inventors: Yochay Danziger, Rishon Le Zion (IL); Eran Herman, Rishon Le Zion (IL); David Menashe, Kiryat Ono (IL); Simon Kahn, Jerusalem (IL)

Correspondence Address: Edward Langer, Pat. Atty., c/o Landon & Stark Associates, One Crystal Park, Suite 210, 2011 Crystal Drive, Arlington, VA, 22202, US

(21) Appl. No.: 09/860,647

(22) Filed: May 21, 2001

Related U.S. Application Data
(60) Provisional application No. 60/206,037, filed on May 22, 2000.

(51) Int. Cl. G02B 6/16; G02F 1/025

(52) U.S. Cl. 385/123; 385/1; 359/161

(57) ABSTRACT

A variable dispersion compensation device utilizing temperature control of the dispersion compensating fiber. Both a high order mode fiber, or a conventional dispersion compensating fiber are utilized. Use of a high order mode fiber with a trimming fiber, each being separately temperature controlled is also described. A method for controlling a system containing the apparatus is also described.

### CROSS-REFERENCE TO RELATED APPLICATIONS

The present application claims the benefit of the filing date of copending U.S. Provisional Application, Ser. No. 60/206,037 filed May 22, 2000, entitled “Method and System for Actively Compensating for Variations in Chromatic Dispersion”.

### FIELD OF THE INVENTION

The invention relates generally to optical communication systems and, more specifically, dispersion compensation in optical systems.

### BACKGROUND OF THE INVENTION

As light travels through a waveguide, such as an optical fiber, it experiences chromatic dispersion, which is caused by the difference in propagation speed experienced by each wavelength. Chromatic dispersion in high bit rate systems, typically those at 10 Gbs and above are typically compensated for by utilizing a dispersion compensating fiber.

Second order dispersion, also known as slope refers to the derivative of the dispersion with regard to wavelength, and reflects the fact that as the wavelength changes the rate of dispersion also changes.

Certain types of chromatic dispersion compensating fibers may also compensate for the slope, most notably those utilizing high order modes, for example co-pending U.S. Patent application Ser. No. 09/249,830 entitled Optical Communication System with Chromatic Dispersion Compensation. New profiles that compensate for dispersion and slope have recently been announced, see for example Nielsen et al, published March 2000, Optical Fiber Communication Conference Technical Digest pages 101/TuG6-1 to 103/TuG6-3.

The chromatic dispersion of an optical fiber is dependent on temperature. See for example Kato et al “Temperature Dependence of Chromatic Dispersion in Various Types of Optical Fibers” published at the Optical Fiber Communications (OFC) conference, March 2000, pages 104/TuG7-1 to 106/TuG7-3. For a typical transmission waveguide having positive dispersion and dispersion slope, such as a single mode fiber, dispersion is reduced as the temperature of the fiber increases. For fibers with negative dispersion slope, such as dispersion compensating fibers, the sign of the variation is reversed, so that dispersion increases (i.e. is less negative) as the temperature increases. This effect is best estimated as a shift in the zero dispersion wavelength. The temperature dependence of the zero dispersion wavelength of transmission lines have been shown to be approximately 0.03 nm/degree C as shown by Ghosh; Temperature Dispersion of Refractive Indexes in Some Silicate Fiber Glasses—IEEE Photonics Technology Letters, Vol. 6 No. 3 March 1994 pp. 431-433.

In land based systems, dispersion compensating devices are often installed in a temperature controlled environment, thus ensuring relative stability. However there is some fluctuation in temperature even in the controlled environment, with typical specifications requiring operation from −5 to 55 degrees C. Transmission lines however, are exposed to changes in environmental temperature, and are typically subject to even wider temperature swings.

In transmitting systems up to 10 Gbs, this temperature dependence is not critical enough to warrant being dealt with. With systems of even higher bit rates, such as a 40 Gbs system it becomes important to compensate for this dispersion. Similarly, extremely long paths at 10 Gbs without reconversion to an electronic signal will require compensation for these temperature fluctuations. Furthermore, at high bit rates any temperature fluctuation of the dispersion compensating fiber must also be controlled.

Thus, there is a need for a system of variable chromatic dispersion compensation of optical fibers.

### SUMMARY OF THE INVENTION

Accordingly, it is a principal object of the present invention to overcome the disadvantages of prior art methods of optical fiber dispersion compensation. This is provided in the present invention by use of variable chromatic dispersion, which is accomplished by controlling the temperature in a dispersion compensation fiber. Raising or lowering the temperature of the dispersion compensating fiber changes the dispersion characteristics of the fiber, thus changing the dispersion compensating characteristics of the fiber.

The present invention relates to an apparatus for variable dispersion compensation, comprising a dispersion compensating fiber whose characteristics are modified by a temperature controlling element.

In accordance with a preferred embodiment of the present invention, there is provided an apparatus for variable dispersion compensation of an optical signal comprising:

a dispersion compensating fiber; and

a first temperature controlling element,

wherein the temperature of said dispersion compensating fiber is modified by said temperature controlling element so as to effect a variable dispersion.

In another embodiment, multiple fibers are utilized, with the temperature of each separately modified and controlled to compensate for temperature dependent chromatic dispersion.

The present invention also relates to a method of variable dispersion compensation comprising the steps of receiving an optical signal, transmitting the optical signal through a dispersion compensating fiber and varying the temperature of the fiber such that the characteristics of the fiber are changed.

In accordance with the present invention, there is provided a method for ensuring stable dispersion compensation comprising the steps of:

supplying a dispersion compensating fiber, and

controlling the temperature of said dispersion compensating fiber so as to maintain said fiber at a specified temperature.

Additional features and advantages of the invention will become apparent from the following drawings and description.

### BRIEF DESCRIPTION OF THE DRAWINGS

The above and further advantages of this invention may be better understood by referring to the following description taken in conjunction with the accompanying drawings in which like numerals designate corresponding elements or sections throughout, and in which:

FIG. 1 illustrates a prior art optical communication system;.

FIG. 2a illustrates a block diagram of an embodiment of a prior art high order mode dispersion compensation device;

FIG. 2b illustrates a block diagram of another prior art dispersion compensation device;

FIG. 2c illustrates a block diagram of another prior art dispersion compensation device;

FIG. 3a illustrates an embodiment of an optical communication system in accordance with the present invention;

FIG. 3b illustrates another embodiment of an optical communication system in accordance with the present invention;

FIG. 4a illustrates a block diagram of an embodiment of a dispersion compensating device in accordance with the present invention;

FIG. 4b illustrates a block diagram of another embodiment of a dispersion compensating device in accordance with the present invention;

FIG. 4c illustrates a block diagram of another embodiment of a dispersion compensating device in accordance with the present invention;

FIG. 5a illustrates a block diagram of a program utilized to control the temperature of a dispersion compensating fiber as shown in FIG. 4a and FIG. 4b in accordance with the present invention;

FIG. 5b illustrates a block diagram of a program utilized to control the temperature of a dispersion compensating fiber as shown in FIG. 4c in accordance with the present invention;

FIG. 6 illustrates an embodiment of a high level block diagram of the program utilized to control the temperature in the dispersion compensating fiber shown in FIG. 5, and

FIG. 7 illustrates an optical communication system according to another embodiment of the invention.

### DETAILED DESCRIPTION OF THE PREFERRED EMBODIMENTS

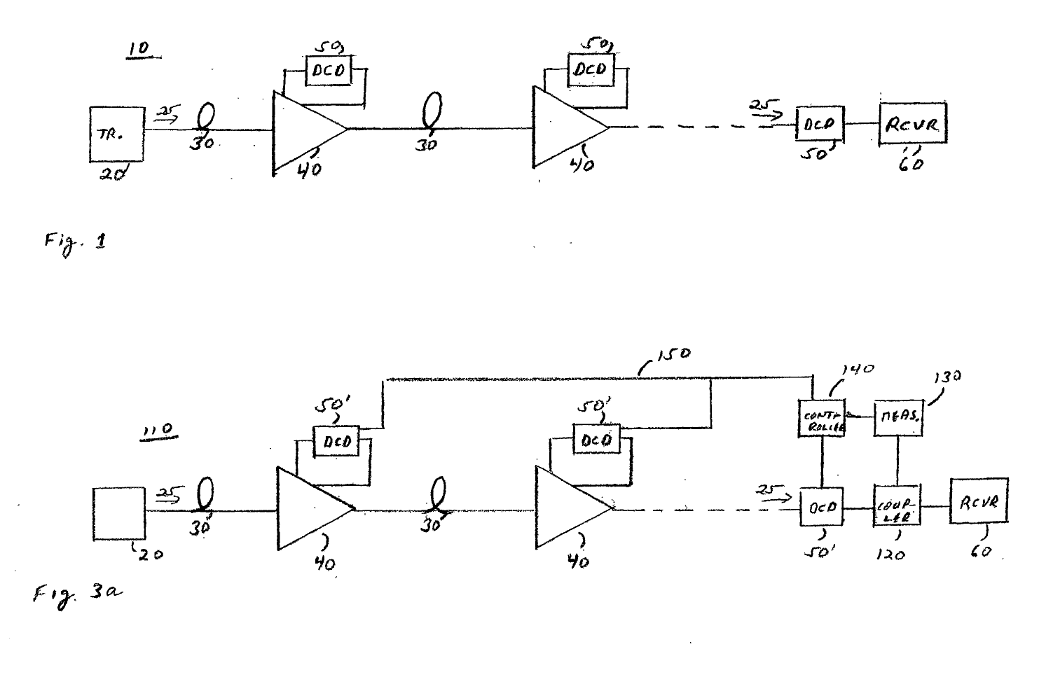

FIG. 1 shows a prior art optical communications system 10 operable at bit rates of 10 Gbs and above. The system 10 comprises a transmitter 20, span of transmission fiber 30, optical amplifier 40 containing a dispersion compensating device (DCD) 50, and a receiver 60. The output of transmitter 20 comprising optical signal 25 is connected to the input of a span of transmission fiber 30, which is meant to include any fiber designed and utilized for long distance transmission, including but not limited to single mode fiber, dispersion shifted fiber and non-zero dispersion shifter fiber. The output of transmission fiber 30 is connected to the input of optical amplifier 40, which contains a DCD 50. Optical amplifier 40 comprises in one embodiment a multiple stage optical amplifier such as an Erbium Doped Fiber Amplifier (EDFA).

The DCD in an exemplary embodiment is positioned between stages of the EDFA. Other configurations are also possible. The DCD 50 in one embodiment comprises a dispersion compensating fiber (DCF), or a combination of mode transformers and a high order mode dispersion compensating fiber, such as one described in co-pending U.S. application Ser. No. 09/249,830 whose contents are incorporated herein by reference. It may also contain multiple fibers for compensating for a combination of dispersion orders, such as one described in co-pending U.S. patent application Ser. No. 09/249,920 whose contents are incorporated herein by reference.

Optical amplifier 40 operates to amplify signal 25, which has been attenuated during transmission through transmission fiber 30. DCD 50 operates to compensate for the chromatic dispersion experienced by signal 25 during transmission through transmission fiber 30, and optical amplifier 40. The output of amplifier 40 is similarly connected to the input of second span of transmission fiber 30, whose output is connected to a second amplifier 40. A number of such spans 30 and amplifiers 40 are connected serially until the optical signal 25 requires electrical regeneration. The output of final span 30 is thus connected to DCD 50 whose output is connected to receiver 60, which converts the optical signal 25 to an electrical signal.

In one embodiment additional system elements such as demultiplexers (not shown) are often utilized prior to the final DCD 50 so that each sub-band may be fully compensated. In an exemplary embodiment transmitter 20 comprises multiple transmitters each operating at a lower frequency being multiplexed together in a wavelength division multiplexed (WDM) configuration, and receiver 60 comprises a demultiplexer and multiple receivers being operated at a lower clock rate, or a single receiver operating at the full clock rate.

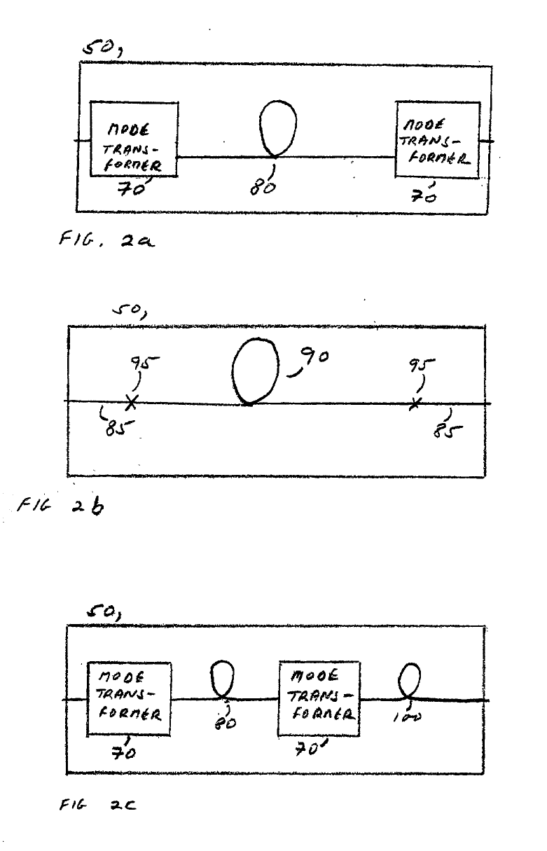

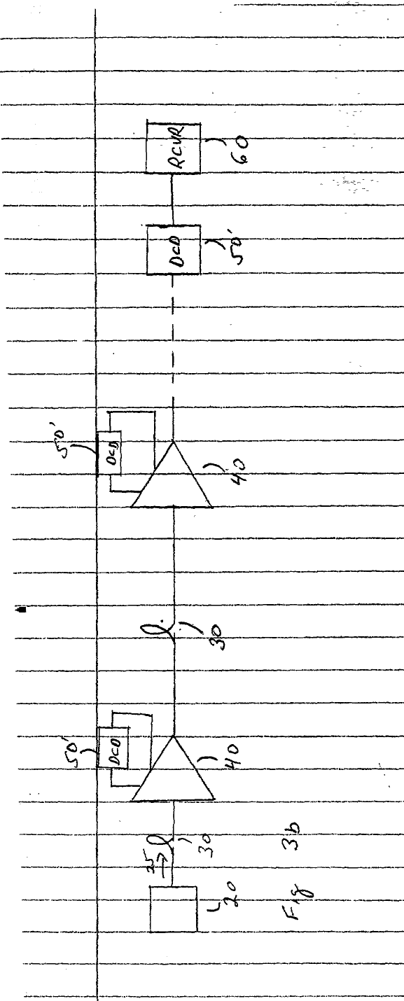

FIG. 2a illustrates an exemplary DCD 50. The device comprises a mode transformer 70, high order mode DCF 80, and a second mode transformer 70. The incoming signal from optical waveguide 20, which is typically in the fundamental mode, also known as the LP₀₁ mode, is converted in the mode transformer 70 substantially to a single high order mode, such as the LP₀₂ mode. DCF 80, compensates for both the dispersion and dispersion slope, following which the signal is reconverted by mode transformer 70 to the LP₀₁ mode.

FIG. 2b illustrates another embodiment of DCD 50, and comprises a spool of single mode DCF 90 connected to a section of conventional single mode fiber 85 by a splice 95. Fiber 90 in one embodiment compensates both dispersion and at least some of the dispersion slope.

FIG. 2c illustrates another embodiment of DCD 50 comprising mode transformer 70, high order mode DCF 80, second mode transformer 70 and single mode fiber 100. Single mode fiber 100 acts to complete the compensation, and has a slope and dispersion whose sign is opposite that exhibited by high order mode DCF 80. The lengths of single mode fiber 100 and DCF 80 are in one embodiment chosen to substantially compensate for the dispersion and slope exhibited by transmission fiber 30.

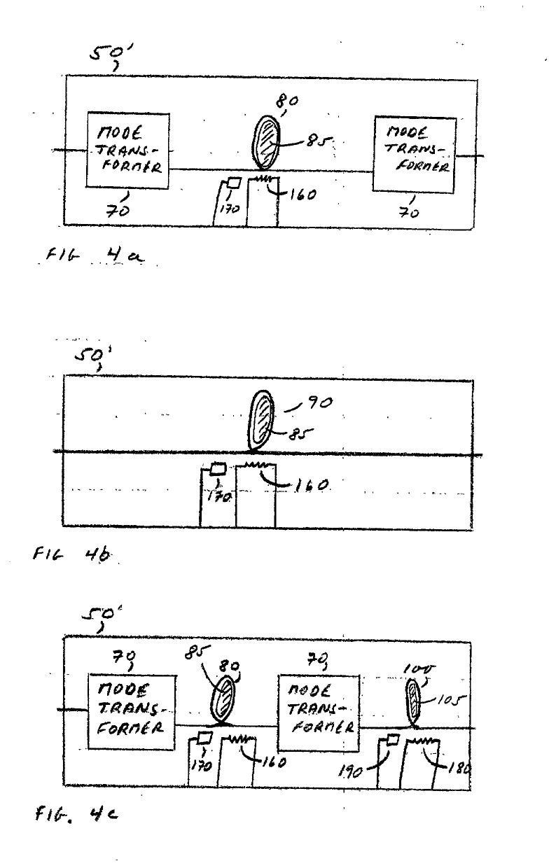

FIG. 3a illustrates system 110 designed according to the teaching of the present invention to compensate for the variability in the chromatic dispersion of the transmitting fiber 30. System 110 comprises a transmitter 20, span of transmission fiber 30, optical amplifier 40 containing a DCD 50′ designed according to the teaching of the present invention, optical coupler 120, dispersion measurement device 130, controller 140, control bus 150, and receiver 60.

Transmitter 20 outputs optical signal 25 into the input of a span of transmission fiber 30, whose output is connected to the input of optical amplifier 40, which contains DCD 50′. Amplifier 40 acts to amplify signal 25 which has been attenuated during transmission through transmission fiber 30. DCD 50′ is controlled via bi-directional bus 150 from controller 140, and operates to compensate in a fixed manner for dispersion and dispersion slope and to actively compensate, as will be explained hereinbelow, for variability in chromatic dispersion experienced by signal 25.

The output of amplifier 40 is similarly connected to the input of a second span of transmission fiber 30, and the output of the second span of transmission fiber 30 is connected to the input of the next amplifier 40. A number of such spans 30 and amplifiers 40 are connected serially until the signal 25 requires electrical regeneration. The final span 20 is thus connected to DCD 50′ whose output is through coupler 120 to receiver 60 which converts the optical signal to an electrical signal. Coupler 120 acts to tap a portion of the signal, and to connect this portion of the signal to dispersion measurement device 130, which acts to measure the overall dispersion of system 110, in a method well known to those versed in the art.

The output of dispersion measurement device 130 is fed as an input to controller 140, which operates in a manner to be explained further below by controlling the temperature of each of the connected DCD 50′ to compensate for any variability in dispersion.

Bus 150 is a bi-directional bus that in one embodiment comprises a control channel transmitted over transmission fiber 30. Controller 110 receives as an input over the bi-directional bus 150 the temperature measurement of each of the attached DCD 50′.

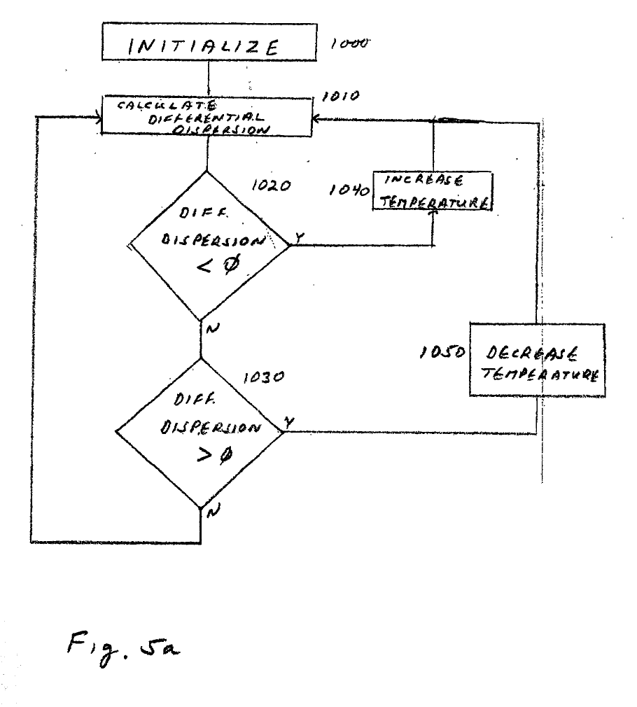

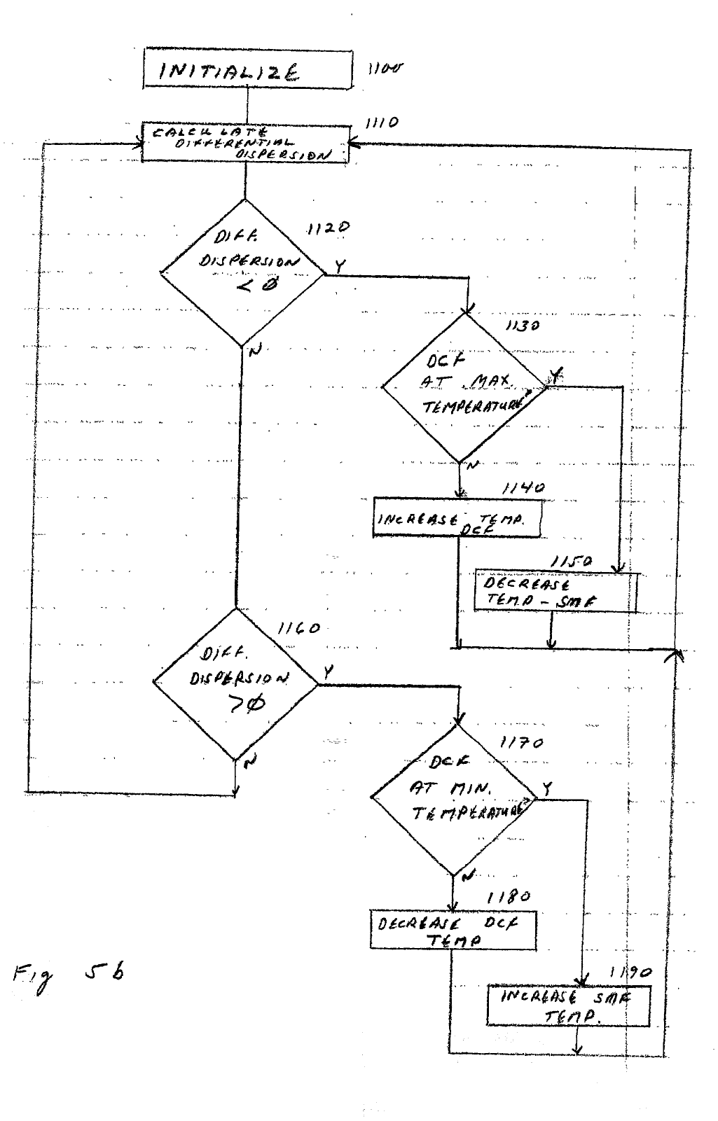

FIG. 3b illustrates another embodiment of an optical communication system utilizing the DCD 50′ of FIG. 4a, 4b or 4c, in which the system comprises a transmitter 20, span of transmission fiber 30, optical amplifier 40 containing DCD 50′ and receiver 60. Temperature elements 160 and 180 are utilized in a fixed mode to maintain the temperature of DCF 80 and SMF 100 at a fixed temperature. In one embodiment, the fixed temperature is a temperature above the ambient temperature. In this embodiment, temperature elements 160, 180 may be heating elements, in which cooling is accomplished by reducing their activation level. By maintaining a fixed temperature, the characteristics of DCF 80 and SMF 100 are kept constant with no variability due to temperature variations.

During initial installation an operating temperature above the maximum expected ambient temperature is selected, and the temperature is maintained by a feedback loop utilizing thermo-coupler 170 and 190 respectively. Maintaining a fixed temperature utilizing a heating element and a thermo-coupler and a simple controller (not shown) is well known to those skilled in the art.

FIG. 4a illustrates a block diagram of one embodiment of DCD 50′, which is a modification of DCD 50 of FIG. 2a according to an embodiment of the present invention and comprises first mode transformer 70, high order mode DCF 80 placed on heat conducting spool 115, temperature element 160, thermo coupler 170 and second mode transformer 70. Temperature element 160 is operated so as to control the temperature of DCF 80. Preferably DCF 80 is a length of fiber placed on a heat conducting spool 115, and temperature element 160 is connected to the spool 115. Thermo coupler 170 is utilized to measure the temperature of the spool, and the temperature is fed over bi-directional bus 150 to controller 140 (FIG. 3a) so as to create a feedback loop.

In one embodiment, temperature element 160 comprises a heating element, which in operation raises the temperature of DCF 80 by heating spool 115. If a lower temperature is desired element 160 is shut off and both spool 115 and DCF 80 lose heat to the surrounding environment until the desired temperature is reached. It is necessary in this embodiment to maintain spool 115 at a temperature above the expected ambient temperature so as to enable passive cooling.

In another embodiment temperature element 160 comprises a thermo electric heating and cooling element, which allows for a wide range of temperature control without regard to the ambient temperature.

FIG. 4b illustrates another embodiment of DCD 50′, which is a modification of the DCD 50 of FIG. 2b according to an embodiment of the present invention, comprising a spool of single mode DCF 90 on a heat-conducting spool 115, temperature element 160 and thermo coupler 170. Element 160 is operated so as to control the temperature of DCF 90. Preferably DCF 90 is a length of fiber placed on a heat-conducting spool 115, and element 160 is connected to the metal spool. Thermo coupler 170 is utilized to measure the temperature of the spool, and the temperature is fed over bi-directional bus 150 to controller 140 (FIG. 3a).

In one embodiment, temperature element 160 comprises a heating element, which in operation raises the temperature of DCF 90 by heating spool 115. If a lower temperature is desired heating element 160 is shut off and the spool 115 and DCF 90 lose heat to the surrounding environment until the desired temperature is reached. It is necessary in this embodiment to maintain spool 115 at a temperature above the expected ambient temperature so as to enable passive cooling. In another embodiment temperature element 160 comprises a thermo electric heating and cooling element, which allows for a wide range of temperature control without regard to the ambient temperature.

FIG. 4c illustrates another embodiment of DCD 50′, which is a modification of the DCD 50 of FIG. 2c according to an embodiment of the present invention, comprising mode transformer 70, high order mode DCF 80 on optional heat conducting spool 115, temperature element 160, thermo coupler 170, second mode transformer 70, single mode fiber 100 on optional heat conducting spool 105, temperature element 180 and thermo coupler 190. Temperature element 160 is operated so as to control the temperature of DCF 80. Preferably DCF 80 is a length of fiber placed on a heat conducting spool 115, and temperature element 160 is connected to the metal spool. Thermo coupler 170 is utilized to measure the temperature of the spool, and the temperature is fed over bi-directional bus 150 to controller 140 (FIG. 3a).

Preferably, single mode fiber 100 is a length of fiber placed on a heat-conducting spool 105, and heating element 180 is connected to the metal spool. Thermo coupler 190 is utilized to measure the temperature of the spool 105, and the temperature is fed over bi-directional bus 150 to controller 140 (FIG. 3a). It is to be understood that temperature elements 160 and 180 can be operated independently of each other.

In one embodiment, temperature element 160 comprises a heating element, which in operation raises the temperature of DCF 80 by heating spool 115. If a lower temperature is desired embodiment element 160 is shut off and the spool 115 and DCF 90 lose heat to the surrounding environment until the desired temperature is reached. It is necessary in this embodiment to maintain spool 115 at a temperature above the expected ambient temperature so as to enable passive cooling, and to insulate the effect of the temperature of spool 115 from spool 105.

In another embodiment temperature element 160 comprises a thermo electric heating and cooling element, which allows for a wide range of temperature control without regard to the ambient temperature or the temperature of spool 105. Proper insulation of the spools 105 and 115 will reduce energy requirements, and prevent undesired temperature swings caused by heat leakage.

In one embodiment, temperature element 180 comprises a heating element, which in operation raises the temperature of single mode fiber 100 by heating spool 105. If a lower temperature is desired heating element 180 is shut off and the spool 105 and single mode fiber 100 lose heat to the surrounding environment until the desired temperature is reached. It is necessary in this embodiment to maintain spool 105 at a temperature above the expected ambient temperature so as to enable passive cooling. In another embodiment temperature element 160 comprises a thermo electric heating and cooling element, which allows for a wide range of temperature control without regard to the ambient temperature.

While the system is described herein in connection with a temperature controlling element and a thermo coupler, this is not meant to be limiting in any way. The element may be replaced with an external heating and cooling system and the thermo coupler may be replaced by another feedback mechanism to control the temperature.

FIG. 5a shows a high level flow chart of one embodiment of the operation of controller 110 of FIG. 3a. The embodiment illustrated will be described in connection with a DCD 50′ as shown in FIG. 4a and FIG. 4b. In step 1000 the system is initialized, including timing constraints for steps. It is to be understood that dispersion changes that are to be compensated in the system are relatively slow, and the temperature change of the DCF 80 and 90 must be stabilized prior to evaluating the effect.

During initialization, the temperature element 160 is set to the middle of the operating temperature range and any trimming of the dispersion compensation is accomplished. This may be done with a variable dispersion element or by replacing a dispersion compensating element with one of a more appropriate value. A small amount of dispersion may be supplied by adjusting the initial temperature of DCF 80 and 90 from the midpoint of the range.

Also during initialization, other factors such as expected temperature swing of transmission fiber 30 from the current ambient temperature must be taken into account by changing the initial set point.

For example, if initialization is being performed on an extremely hot day, transmission fiber 30 is at its hottest temperature and thus at its minimum dispersion as regards any temperature dependent effect. The initial set point thus must allow for maximum additional negative compensation as the single mode fiber will typically experience higher amounts of dispersion as it experiences cooler temperatures. A calculated value may be utilized.

In the embodiment where a heating element is utilized, the environment of the DCD 50′, as well as the external environmental temperature of transmission fiber 30 must be taken into account, with the temperature range selected to be always above that of the environment of DCD 50′. The current dispersion value as shown as indicated by dispersion measurement device 130 is stored as a baseline.

In step 1010, the differential dispersion of the system is calculated based in the input from dispersion measurement 130. Step 1010 sets a timer, so that it may not operate more than once an hour. While once an hour is an exemplary time, it is to be understood that other timing factors may be utilized, with the major factor being the need for the system to stabilize.

In step 1020, the differential dispersion is examined. If the differential dispersion is less than zero, the dispersion has decreased which may be partially caused by an increase in the temperature of the transmitting fiber 30. The controller than proceeds to step 1040, which operates to increase the temperature of DCD 80 of FIG. 4a or DCD 90 of FIG. 4b respectively, by ten degrees C, through the operation of temperature element 160, as monitored by thermo coupler 170. The system then proceeds to step 1010, which will calculate the differential dispersion again after 1 hour, which is the preset time to allow for the system to stabilize.

In the event that the differential dispersion has not decreased, step 1030 operates to check whether the differential dispersion is positive, i.e. has the dispersion increased. If the differential dispersion is positive, which may be caused by among other factors the temperature of transmitting fiber 30 having decreased, step 1050 is run, which operates to decrease the temperature of DCD 80 of FIG. 4a or DCD 90 of FIG. 4b respectively by ten degrees C, through the operation of temperature element 160, as monitored by thermo coupler 170.

The system then proceeds to step 1010, which will compare the differential dispersion again after 1 hour, so as to allow for the system to stabilize. In accordance with the system shown in FIG. 3a, the temperature elements of all of the DCD's of the system are operated under the same control, so as to compensate for any drift in the overall system.

In the event that at step 1030 it is determined that the differential dispersion has not increased, the system proceeds to step 1010, which will compare the differential dispersion again after 1 hour.

FIG. 5b illustrates a high level flow chart of another embodiment of the operation of controller 110 of FIG. 3a, in connection with a DCD 50′ as shown in FIG. 4c. In step 1100 the system is initialized, including timing constraints for steps as well temperature step size. In an exemplary embodiment 1 hour is used as the timing constraint and 10 degrees C is used as the temperature step. Other timing constraints and step sizes may be utilized without exceeding the scope of the invention. It is to be understood that temperature changes in the system are relatively slow, and the temperature must be stabilized prior to evaluating the effect.

In the initialization, the temperature elements 160 and 180 are set to their midpoints, so that the DCD 80 and SMF 100 may reach the midpoints of their operating temperature ranges, and any trimming of the compensation must be accomplished by external means. A small amount of dispersion may be supplied by adjusting the initial temperature of DCF 80 and SMF 100 from the midpoint of the range. During initialization, other factors such as expected temperature swing of transmission fiber 30 from the current ambient temperature must be also be taken into account by changing the initial set point. The current dispersion value as shown as indicated by dispersion measurement device 130 is stored as a baseline.

In step 1110 the differential dispersion of the system is calculated based in the input from dispersion measurement 130. Step 1110 sets a timer, so that it may not operate more than once an hour. While once an hour is an exemplary time, it is to be understood that other timing factors may be utilized.

In step 1120 the differential dispersion is examined. If the differential dispersion is less than zero, the dispersion has decreased which may be caused by an increase in the temperature of the transmitting fiber 30. The controller then proceeds to step 1130, which checks whether DCF 80 is within 10 degrees C, the step size, of its maximum operating temperature. If it is not, the controller proceeds to step 1140, which operates to increase the temperature of DCF 80 by ten degrees C. The controller then returns to step 1110, which will operate again after a delay of one hour.

If in step 1130 the DCF is found to be within 10 degrees C of its maximum temperature, step 1150 is operated, which functions to decrease the temperature of SMF 100 by its step size, counterbalancing the temperature dependent dispersion of transmitting fiber 30. The controller then returns to step 1110, which will operate again after a delay of one hour. The step size of SMF 100 in an exemplary embodiment is the same as that of DCF 80, namely 10 degrees C. Other step sizes may be utilized, and there is no requirement that the step size of SMF 100, or the fixed time delay of SMF 100 be the same as that of DCF 80.

If in step 1120 the differential dispersion is not found to be less than zero, step 1160 is operated, and the controller checks whether the differential dispersion is greater than zero. If it is not greater than zero, the controller returns to step 1110, which will operate after a delay of one hour.

If in step 1160 the differential dispersion is found to be greater than zero, the controller proceeds to step 1170, which checks to see whether DCF 80 is at its minimum operating temperature. If it is not, step 1180 is operated, which functions to decrease the operating temperature of DCF 80 by the step size of ten degrees. The controller then returns to step 1110, which will operate after the delay time.

If in step 1170, DCF 80 is found to be at its minimum operating temperature, step 1190 is operated, which functions to increase the temperature of SMF 100, which functions to counterbalance the variable dispersion of transmitting fiber 30. The controller then returns to step 1110, which will operate again after a delay of one hour.

Thus, SMF 100 in FIG. 4c allows for a broader operating temperature range than that shown in FIG. 4a.

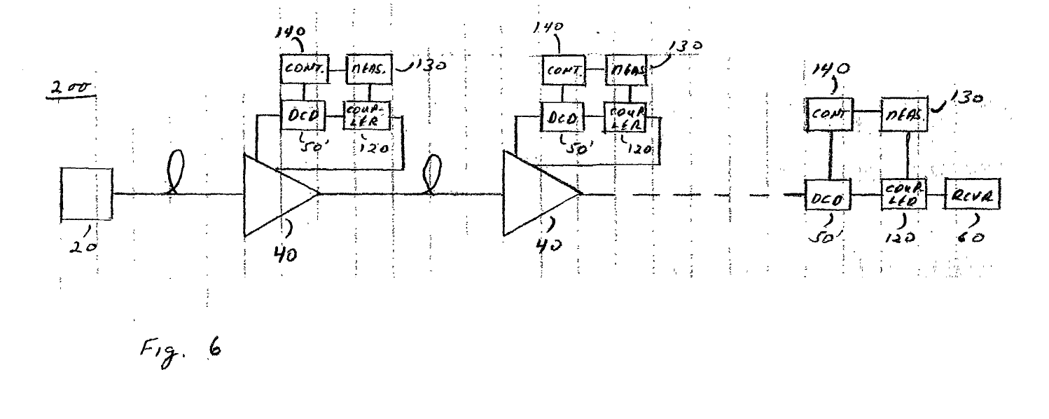

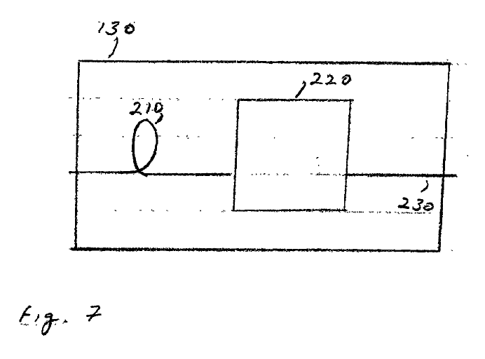

FIG. 6 shows another embodiment of a system 200 according to the present invention, utilizing multiple dispersion measurement devices 130, couplers 120 and controllers 140. For each DCD 50′, a coupler 120, dispersion measuring device 130 and controller 140 is supplied to control the heating element of the DCD 50′. The system is more costly, however it has the advantage being able to compensate each span 30 independently. It is often advantageous to ensure nominal zero dispersion at the amplifier 40, which can be accomplished by the system 160.

FIG. 7 shows an embodiment of a dispersion measurement device 130 according to the present invention, comprising SMF 210, oscilloscope 220, and output digital data 230. The signal from coupler 120 is transmitted through a suitable length of SMF fiber, such as a 1 kilometer spool, with a known dispersion. This is utilized as an offset, to enable the controller 140 to identify the direction of resultant dispersion. SMF 210 is connected to the input of oscilloscope 220, such as an Agilent 86100 wide bandwidth oscilloscope, available from Agilent Technologies, Palo Alto, Calif., which is programmed to output a calculation of the Q factor of the received signal. The Q-factor is output from the oscilloscope 220 over data lines 230, which may be an RS-232 bus or other suitable communication path.

In the event that the Q-factor has improved from its previous state, this indicates that the positive dispersion added by SMF 210 has been somewhat compensated for by having less dispersion in transmission fiber 30. Corrective action is called for, and controller 110 will issue a command according the relevant instructions as shown in FIG. 5a and FIG. 5b respectively. The offset of SMF 210 is important, as the temperature of the DCF 80 or DCF 90 cannot be rapidly swept. The exact direction must be identified in order to take the slow but correct response. Other dispersion measurement devices may be utilized without exceeding the scope of the invention.

A high order mode fiber exhibits high negative dispersion and dispersion slope, which allows for a short length of fiber to be utilized while compensating for a long length of transmission SMF. Dispersion on the order of −200 ps/mn/km is a typical value, with slope on the order of −4 to −5 ps/nm²/km being typical. High order mode fibers exhibit shifts in temperature similar to other fibers, i.e. approximately 0.03 nm/° C. A typical span of 80 kilometers of non-zero dispersion shifted fiber exhibits 200-300 ps/nm dispersion and is compensated for by a length of 1-2 kilometers of high order mode fiber with a length of single mode fiber as a trimming fiber to match the specific dispersion and slope characteristics of the transmission span.

As a specific example, shifting the temperature of a 1.5 kilometer span of high order mode fiber, with a slope of −4.5 ps/nm²/km at 1550 nm, by +10° C., effects a dispersion shift of:

(Temperature dependence of zero dispersion wavelength)×(Slope of fiber)×(Length of fiber)×(Temperature shift)=

0.03 nm/° C.×4.5 ps/nm²/km×1.5 kilometer×10° C.=−2.0 ps/nm.

It is to be understood that other methods of dispersion measurement can be utilized in connection with the invention. All that is required is a means of identifying the direction of dispersion correction required. Various methods are known to those skilled in the art and will not be further described.

In addition, the system has been described in connection with the temperature control of a high order mode dispersion compensating fiber connected in series with a single mode fiber as a trimmer. This is not meant to be limiting in any way, and is meant to include the use of a standard dispersion compensating fiber with a trimming fiber, and to include the use of a second high order mode fiber as a trimming fiber. The single mode fiber being used as a trimming may fiber, is one embodiment a standard single mode fiber such as SMF-28® sold by Corning, Inc. In another embodiment it is dispersion shifted fiber, and in still another embodiment comprises non-zero dispersion shifted fiber.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. An apparatus for variable dispersion compensation of an optical signal comprising:
a dispersion compensating fiber; and
a first temperature controlling element,
wherein the temperature of said dispersion compensating fiber is modified by said temperature controlling element so as to effect a variable dispersion.

2. An apparatus according to claim 1 wherein said first temperature controlling element is a heating element.

3. An apparatus according to claim 1 wherein said first temperature controlling element comprises a thermoelectric element.

4. An apparatus according to claim 1, further comprising a temperature sensing element.

5. An apparatus according to claim 1 further comprising a dispersion measurement means.

6. An appartus according to claim 5 wherein said dispersion measurement means contains a length of fiber utilized as an offset to determine direction.

7. An apparatus according to claim 1 wherein said dispersion compensating fiber is a high order mode fiber.

8. An apparatus according to claim 7 further comprising a mode transformer for converting the optical signal to a high order mode.

9. An apparatus according to claim 1 further comprising a single mode fiber and a second temperature element, said second temperature element being independently controllable from said first temperature element.

10. An apparatus according to claim 1 further comprising a spool containing said dispersion compensating fiber wherein said first temperature controlling element modifies the temperature of said spool.

11. A method for variably compensating for dispersion of an optical signal, said method comprising the steps of;
receiving the optical signal,
transmitting the optical signal through a dispersion compensating fiber, and
varying the temperature of said dispersion compensating fiber, such that said dispersion compensating fiber exhibits variable dispersion at varying temperatures.

12. A method according to claim 11 wherein said temperature variation is accomplished by heating said dispersion compensating fiber.

13. A method according to claim 11 wherein said temperature variation is accomplished by at least one of heating and cooling said dispersion compensating fiber.

14. A method according to claim 11, further comprising the step of sensing the temperature of said dispersion compensating fiber.

15. A method according to claim 11 further comprising the step of measuring a direction of dispersion of said optical signal.

16. A method according to claim 15 further comprising the step of supplying a fixed dispersion offset to said optical signal.

17. A method according to claim 11 further comprising the step of measuring the dispersion of said optical signal.

18. A method according to claim 11 further comprising the step of transforming the optical signal to a high order mode.

19. A method according to claim 11 wherein said temperature variation is applied to a spool having mounted thereon said dispersion compensating fiber.

20. A method for ensuring stable dispersion compensation comprising the steps of:
supplying a dispersion compensating fiber, and
controlling the temperature of said dispersion compensating fiber so as to maintain said fiber at a specified temperature.

21. The method according to claim 20 further comprising the step of heating said fiber to a temperature above an expected ambient maximum temperature.
